(19) United States
(12) Patent Application Publication
(10) Pub. No.: US 2017/0337560 A1
(43) Pub. Date: Nov. 23, 2017

(54) SYSTEM FOR PROVIDING AND EMPLOYING RECOMMENDED RESOLUTION PATHS

(71) Applicant: Microsoft Technology Licensing, LLC, Redmond, WA (US)

(72) Inventors: Shih Chia Wang, Taipei (TW); MingChieh Chang, Taipei (TW); Wen-Chun Sun, Taipei (TW)

(21) Appl. No.: 15/157,227

(22) Filed: May 17, 2016

(51) Int. Cl. G06Q 30/00; G06F 3/0482; G06F 3/0484; G06Q 10/06

(52) U.S. Cl. CPC G06Q 30/016; G06Q 10/0631; G06F 3/0482; G06F 3/04842

(57) ABSTRACT

Described herein are techniques and systems for providing an interactive user interface that presents a set of recommended resolution paths and resolution actions to resolve a user issue. The recommended resolution paths and resolution actions presented can be selected from a database of resolution paths and resolution actions previously employed by technicians to resolve user issues. The database of resolution paths can be accessible by computing devices associated with the technicians, and can store the different resolution paths and resolution actions employed by each of the technicians. Once the user issue has been resolved, the system can determine that the current resolution path has successfully resolved the issue, and update the database to include the current resolution path and/or change the scores associated with the current resolution path.

### BACKGROUND

In addition to providing software, it is common for software providers to also provide services that enable software users to consult with on call technicians to resolve their software related issues. Additionally, because versions of software that are distributed to different users are similar, when a first user has an issue with the software, this issue can often be endemic to the software itself. Therefore, when an on call technician receives a call about a particular software issue, the technician can expect that a different caller has previously called or will likely call the service in the future with regard to the same software issue.

When on call technicians receive a call for an issue that a technician has previously resolved, the on call technician leverages his or her past experiences with the issue when determining what actions to take to resolve the issue. Different technicians will deal with the same problem but have no effective way of sharing the experience. Additionally, even if the technician who receives the call has previously dealt with the particular software issue, a different technician may know of a more effective solution.

### SUMMARY

Described herein are techniques and systems for generating, accessing, modifying, and leveraging the communal knowledge of a group of on call technicians to improve issue resolution services. In some instances, as a technician engages in the investigation of a user issue, the techniques and systems provide an interactive graphical user interface that presents a set of recommended resolution paths to resolve the user issue, where the set of recommended resolution paths is selected from a database of resolution paths previously employed to resolve user issues. A resolution path can include one or more resolution actions (e.g., a series of resolution actions) that can be performed to resolve the user issue. The database of resolution paths can be accessible by one or more computing devices associated with one or more technicians, and can store the different resolution paths and resolution actions employed by each of the on call technicians.

In some instances, the techniques and systems can assign scores to individual resolution paths stored in the database. The scores can reflect a likelihood that a corresponding resolution path is the best resolution path for resolving a user issue. The techniques and systems can then select a set of recommended resolution paths to present on a user interface presented on a technician's computing device based at least partly on the scores. For example, a recommended resolution path can be presented as a directed acyclic graph, where individual nodes of the graph correspond to individual resolution actions. The user interface can then allow the technician to select a resolution path of the recommended set of resolution paths, and proceed through the resolution actions of the selected resolution path.

In some instances, the user interface can also allow the technician to edit the selected resolution path. For example, in response to a selection of a resolution action within the selected resolution path, the user interface can enable the technician to submit edits to the selected resolution path. Based on the edits submitted by the technician, the user interface can update the presentation of the selected resolution path to reflect the edited state of the resolution path. In some instances, based on the selection of a resolution action within the selected resolution path, the user interface can present one or more selectable resolution actions that are recommended to be included in the selected resolution path.

In some instances, when the system is unable to identify an appropriate resolution path to resolve a user issue, the user interface may not present a recommended resolution path. In such situations, the user interface can assist the technician to create a new resolution path by presenting selectable resolution actions on the user interface. In response to a selection of a selectable resolution action, the user interface can present one or more selectable next resolution actions. The user interface can also present a graphical representation of the new resolution path that reflects its current state.

Once the user issue has been resolved, the techniques and systems can determine that the current resolution path (i.e., the selected resolution path, the edited resolution path, the new resolution path, etc.) successfully resolved the issue. Moreover, the techniques and systems can update the database to include the current resolution path and/or change one or more the scores associated with the current resolution path.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicates similar or identical items.

FIG. 1 illustrates an example environment in which technicians can be provided with an interactive graphical user interface that presents recommended resolution paths and/or resolution actions for addressing a user issue.

FIG. 2 illustrates a schematic diagram of components of a technician computing device that are configured to provide a user interface to recommend a resolution path and/or resolution actions to resolve user issues.

FIG. 3 illustrates a schematic diagram of components of a server device that are individually configured to provide a user interface to recommend a resolution path and/or resolution actions and resolution actions to resolve a user issue.

FIG. 4 illustrates a flow diagram of an example process for providing a user interface configured to recommend resolution paths and/or resolution actions to resolve a user issue.

FIG. 5 illustrates a flow diagram of an example process for providing technicians with an interactive graphical user interface to assist the technician in editing a resolution path to resolve a user issue.

FIG. 6 illustrates a flow diagram of an example process for providing technicians with an interactive graphical user interface that assists technicians in generating a new resolution path to resolve a user issue.

### DETAILED DESCRIPTION

The techniques and systems described herein implement a tool that provides technicians with an interactive user interface (UI) that presents recommended resolution paths and/or resolution actions for addressing a user issue. A resolution path can include one or more resolution actions (e.g., a series of resolution actions) that a technician can implement and/or execute to resolve a user issue. In various examples, a resolution action is an individual step that a technician can take during the process of resolving the user issue.

In some instances, the tool can maintain a database of resolution paths that have been utilized in the past to address different user issues. The resolution paths stored in the database can be created and/or used by one or more different technicians to resolve many different types of user issues. When a technician begins to investigate a user issue, the tool can identify a set of one or more resolution paths in the database to present to the user as recommendations to resolve the user issue. For example, the tool can identify a set of resolution paths that are each related to the same type of issue as the user issue. The tool can then assign a score to individual resolution paths of the set of resolution paths, wherein individual scores reflect the likelihood that a corresponding resolution path represents the best course of action for the technician to implement and/or execute to resolve the user issue.

In some examples, a score can be assigned to a resolution path based at least in part on one or more individual action scores that are associated with the one or more resolution actions that make up the resolution path. Alternatively or in addition, the scores can be assigned based at least partly on how often the resolution path is used by technicians, and/or the amount of time that has expired since the resolution path was last used. For example, a resolution path that is often employed by technicians to resolve previous issues of the same or similar type is likely to be effective in resolving a current issue of the same or similar type. Moreover, a large amount of time having elapsed since a resolution path was last used can correspond to a greater likelihood that the issue has been fixed (e.g., via a global software patch), and that the resolution path is obsolete.

The tool can then select one or more recommended resolution paths based on the score, and present the one or more recommended resolution paths to the technician via the UI. In some examples, the UI can present the one or more recommended resolution paths as one or more directed acyclic graphs, where individual nodes of the graph can correspond to individual resolution actions. The tool can further present a recommended resolution path and/or one or more individual resolution actions within the recommended resolution path as selectable elements within the UI. In some instances, selection of an individual resolution action can cause the tool to execute the action. Selection of an individual resolution action can also cause the tool to input the corresponding action into a command box. The technician can then be able to execute and/or implement the action via the command box. In this way, the UI can enable the technician to progress through the resolution actions of a recommended resolution path.

In various examples, the UI can also present one or more resolution actions separate from the recommended resolution paths. In some instances, the tool can store one or more resolution actions in the database of resolution paths. The UI can assign a score to individual resolution actions, where individual scores reflect the likelihood that a corresponding resolution action represents the best course of action for the technician to implement and/or execute to resolve the user issue. In some instances, the tool can select a subset of resolution actions to present on the UI based at least partly on the scores of the resolution actions. Alternatively or in addition, the UI can provide a selectable option (i.e., drop down menu, toolbar, selectable icons, etc.) that enables the technician to select the type of actions that are presented on the UI. For example, in response to a technician selection of a menu item corresponding to “General Purpose” actions, the UI can display one or more resolution actions of the type “General Purpose.” In some examples, the one or more resolution actions of the selected type that are displayed on the UI can be included in the UI based at least partly on the corresponding scores.

In some instances, the UI can enable the technician to edit a displayed resolution path. For example, in response to a selection of a resolution action within a displayed resolution path, the UI can present a selectable option to remove the selected resolution action from the resolution path. In some examples, the UI can present a visual indicator (e.g., a grayed out action icon) that the selected resolution action has been removed. Alternatively or in addition, in response to a selection of a resolution action, the UI can allow the technician to select a different resolution action that is to be added to the resolution path. In response to the technician selecting to add a new resolution action to the resolution path, the UI can update the presentation of the resolution path to reflect the edited state of the resolution path.

In some instances, based on the selection of a resolution action within the resolution path, the user interface can present and/or recommend one or more subsequent resolution actions to be included in the resolution path. The technician can then select the subsequent resolution action in the resolution path, or select one of the one or more recommended resolution actions presented on the user interface. For example, in response to the selection of a resolution action, the tool can assign scores to individual resolution actions, wherein individual scores reflect the likelihood that a corresponding resolution action represents the best resolution action to precede, follow, and/or replace the selected resolution action. The tool can select a subset of the scored resolution actions to present on the UI.

In some instances, when the tool is unable to identify an appropriate resolution path to resolve a user issue, the user interface may not present a recommended resolution path. For example, after assigning scores to one or more resolution paths stored in the database, the tool can determine that none of the scores meet or exceed a preset threshold. In such situations, the UI can enable the technician to create a new resolution path by selecting a resolution action presented on the user interface. For example, the tool can assign a score to individual resolution actions stored in the database, wherein individual scores reflect the likelihood that a corresponding resolution action represents the best first action to resolve the user issue. The UI can display a selection of recommended first resolution actions based upon the scores. Once the technician has selected a first resolution action, the tool can assign a new score to individual resolution actions stored in the database, wherein the individual new scores reflect the likelihood that a corresponding resolution action represents the best second action to implement and/or execute after the first action. The UI can display a selection of recommended second resolution actions based upon the scores. The UI can continue to recommend next actions until the user issue is resolved. In some examples, the UI can present a graphical representation of the new resolution path that the technician is generating that reflects the current state of the new resolution path.

In some instances, once the tool determines that the user issue is resolved (e.g., notification from user computing device, input from technician via the UI, etc.) the tool can update the database to reflect that the resolution path (e.g., the selected resolution path, the edited resolution path, the new resolution path, etc.) successfully resolved the user issue. In some instances, the system can update the database to include the new/edited resolution path and/or change one or more the scores associated with the version of the resolution path stored in the database. In this way, the next time a technician initiates an investigation relating to the user issue (e.g., when a second user experiences the user issue), the scores and recommendations are based at least partly on the updated database.

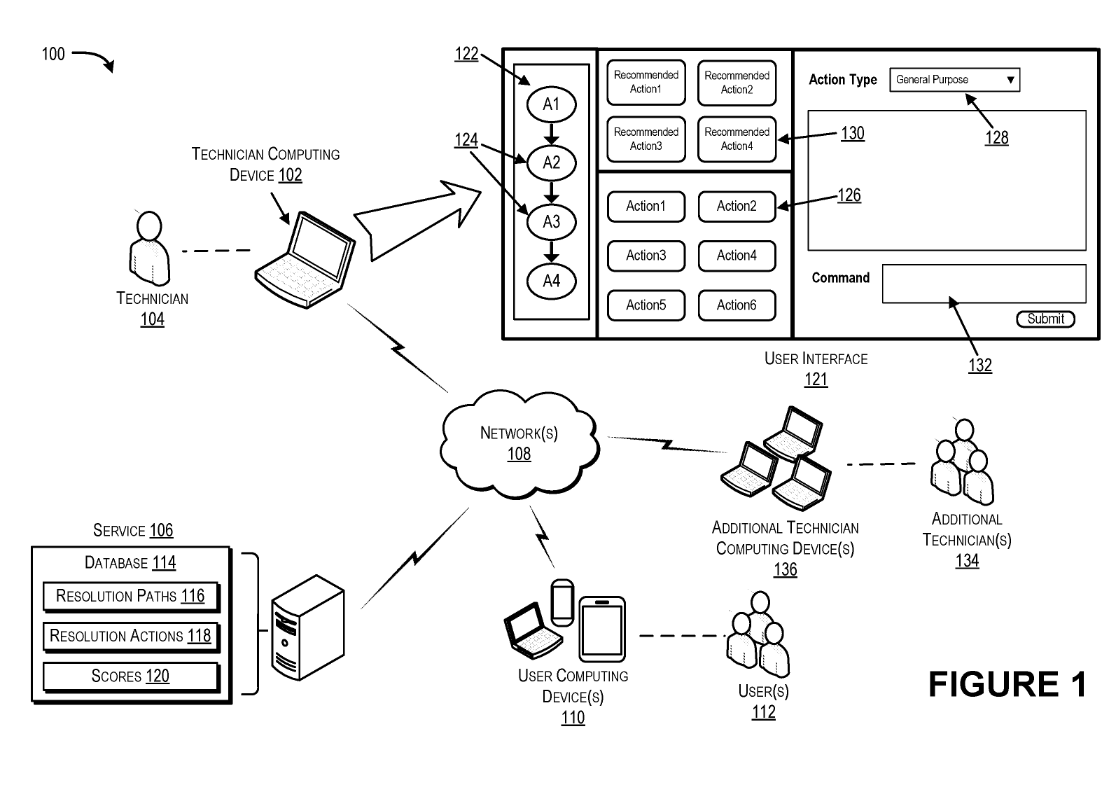

FIG. 1 is a schematic diagram of an example environment 100 in which technicians can be provided with an interactive graphical user interface that presents recommended resolution paths and/or resolution actions for addressing a user issue. Additional details of individual features illustrated in FIG. 1 are described in more detail with reference to subsequent figures.

The environment 100 includes a technician computing device 102 associated with a technician 104. The technician computing device 102 can be implemented as any type of computing device including, but not limited to, a personal computer, a laptop computer, a tablet computer, a portable digital assistant (PDA), a mobile phone (e.g., a smart phone), a smart device having a touchscreen interface, and so forth. The technician computing device 102 can be in communication with a service 106 via a network 108 such as, for example, the internet or a local wireless network. The environment 100 further includes one or more user computing devices 110 (e.g., personal computers, laptop computers, tablet computers, PDAs, mobile phones, electronic book (e-book) readers, game consoles, set-top boxes (STB), smart televisions (TV), portable game players, portable media players, etc.) associated with one or more users 112. The service 106 can be implemented or hosted by one or more servers, server farms, data centers, or any of the other computing devices listed above.

FIG. 1 illustrates the service 106 hosting a database 114. The database 114 can include resolution paths 116, resolution actions 118, and scores 120 associated with the resolution paths 116 and/or the resolution actions 118, as further described herein. A resolution path 116 can be one or more resolution actions 118 (e.g., a series of resolution actions) that the technician 104 can implement and/or execute via the technician computing device 102 to resolve a user issue. A user issue can include an issue that a user of the one or more additional users 112 is experiencing with a user computing device 110 (e.g., software installed and/or executing on the user computing device 110). In various examples, the user can be a subscriber, a licensee, a client, a consumer, etc. A resolution action 118 can include an individual step or operation that the technician 104 can implement and/or execute via the technician computing device 102 during the process of resolving the user issue. The service 106 can make the database 114 available to the technician computing device 102. In the illustrated example, the service 106 is implemented by one or more server(s).

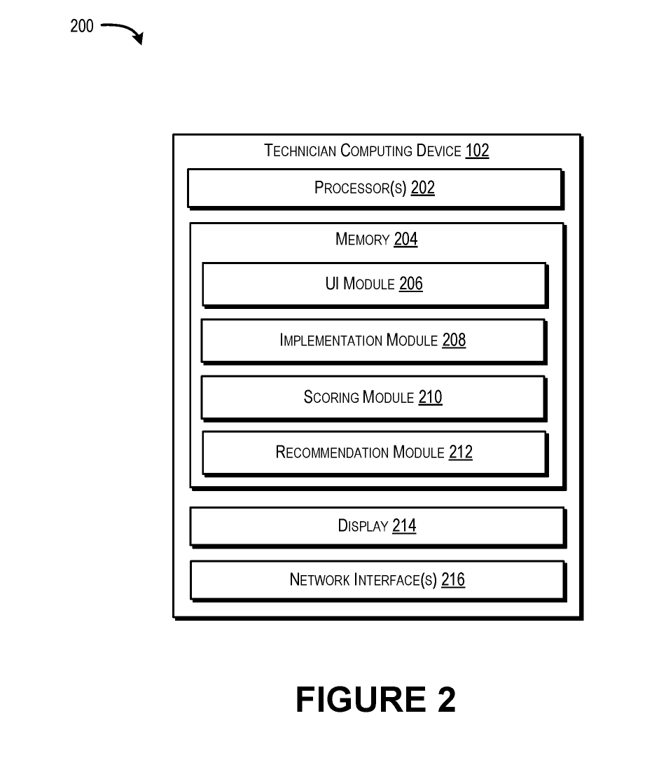

The technician computing device 102 can include one or more processors and memory communicatively coupled to the processor(s), as further described with respect to FIG. 2. Data stored on the memory of the technician computing device 102 can include an operating system, one or more applications, and one or more modules associated with the computing system disclosed herein. In a different embodiment, database 114 can be stored on the memory of the technician computing device 102. The technician computing device 102 can further include a display upon which a user interface (UI) 121 can be displayed.

The UI 121 can include a visual representation 122 of a resolution path (e.g., corresponding to one of resolution paths 116). In some examples, the visual representation 122 of a resolution path can be a directed acyclic graph, where individual nodes 124 of the graph can correspond to individual resolution actions 118. The resolution path 116 corresponding to visual representation 122 can be selected based at least in part on a score 120 indicating that the resolution path 116 represents the best course of action for the technician to implement and/or execute to resolve the user issue being experienced by a user 112. In some examples, the UI 121 can enable the technician 104 to edit the visual representation 122 of a resolution path.

The UI 121 can also include one or more selectable resolution actions 126 separate from the visual representation 122 of a resolution path. Individual selectable resolution actions 126 can each correspond to a resolution action 118. The UI 121 can also include a selectable option 128 (e.g., drop down menu, toolbar, selectable icons, etc.) that enables the technician 104 to select the type of resolution actions 118 that are presented as selectable resolution actions 126 on the UI 121.

The UI 121 can also include one or more recommended resolution actions 130 (e.g., selected from resolution actions 118 and/or resolution actions 126). The recommended resolution actions 130 can be selected based at least in part on a score 120 indicating a likelihood of the resolution action representing the best resolution action for the technician to implement and/or execute to resolve the user issue being experienced by the user 112. In some examples, the score 120 can be based at least partly on a previous action executed and/or implemented by technician 104. For example, after the technician 104 executes individual node A2 124 of the visual representation 122 of the resolution path, the UI 121 can present one or more recommended resolution actions 130 that are alternatives to individual node A3. In some instances, these recommended resolution actions 130 may be selected for presentation on the UI 121 based on scores 120 indicating that the recommended resolution actions 130 are the best alternatives to the resolution action corresponding to individual node A3.

In some examples, when the technician 104 selects one of the selectable resolution actions 126 and/or recommended resolution actions 130 (e.g., when the resolution action within the resolution path does not work, or the technician 104 believes the resolution action is not the best next action to pursue to solve the user issue), the UI 121 will insert a new node corresponding to the selected action into the visual representation 122. In some instances, the UI 121 can then present a new set of recommended actions that are selected based on scores 120 indicating that they are the best resolution actions for the technician 104 to execute after the selected action. In this way, when the resolution path fails to address the user issue, or if the technician believes that the resolution path is not the best method for addressing the user issue, the UI 121 dynamically adapts the selectable options it presents to assist the technician 104 in building a revised resolution path. Additionally, as the selection of one of the selectable resolution actions and/or recommended actions in lieu of a resolution action within the recommended resolution path represents a decision by the technician 104 to deviate from the recommended resolution path, a score 120 associated with the recommended resolution path may be updated (e.g., reduced). Alternatively or in addition, when the technician 104 selects to remove a particular resolution action from the recommended resolution path and/or add a new resolution action to the recommended resolution path, a first score associated with the particular resolution action removed may be decreased with regard to the user issue and/or a second score associated with the new resolution action added may be increased with regard to the user issue.

In some examples, the UI 121 can enable the technician 104 to create a new resolution path 118. For example, the UI 121 can present selectable resolution actions 126 and/or recommended resolution actions 130. Then, in response to the technician 104 selecting a first action of the selectable resolution actions 126 and/or recommended resolution actions 130, the UI 121 may present a node corresponding to the selected first action. The UI 121 may then dynamically present a new set of recommended actions that are selected based on scores 120 indicating that they are the best resolution actions for the technician 104 to execute after the first selected action. In some instances, as the technician 104 continues to select additional resolution actions 126 and/or recommended resolution actions 130, the UI 121 presents an acyclic graph where each individual node corresponds to a selected action.

In some instances, a selection of an individual node 124, a selectable resolution action 126, and/or a recommended resolution action 130 can implement and/or execute a corresponding resolution action 118. In some examples, a selection of an individual node 124, a selectable resolution action 126, and/or a recommended resolution action 130 can cause a corresponding resolution action 118 to be presented in command box 132. The technician 104 can then execute and/or implement the corresponding resolution action 118 via the command box 132.

In some instances, once the user issue is resolved, database 114 can be updated to reflect that the resolution path (e.g., the selected resolution path, the edited resolution path, the new resolution path, etc.) successfully resolved the user issue. For example, if the technician 104 uses the selected resolution path, the score 120 corresponding to the selected resolution path in the database 114 may be increased. Alternatively, if the technician 104 used a revised resolution path (e.g., based on user removal and/or additions of resolution actions) or a new resolution path to resolve the user issue, the score 120 corresponding to the selected resolution path in the database 114 may be decreased, and the new or revised resolution path may be added to the database 114. Moreover, a new score corresponding to the new or revised resolution path may be added to the database 114. For example, the new or revised resolution path may be assigned a higher score 120 in the database 114 than the selected resolution path in relation to the user issue. In this way, the next time a technician 104 initiates an investigation of a same or similar issue, the new or revised resolution path will be recommended over the selected resolution path.

In this way, each time the technician 104 initiates an investigation relating to a user issue, or an additional technician 134 via an additional technician computing device 136 initiates an investigation relating to a same or similar user issue, the tool is able to provide an interactive graphical user interface that presents recommended resolution paths and/or resolution actions that takes into account prior issue resolutions performed by technician 104 and/or additional technicians 134.

FIG. 2 is a schematic diagram 200 illustrating components of an example technician computing device 102 configured to recommend a resolution path and/or resolution actions to resolve user issues. For instance, FIG. 2 illustrates additional details of hardware and software components that can be used to implement the techniques described above with respect to FIG. 1. Additionally, individual hardware and software components illustrated in FIG. 2 can exist in an additional technician computing device 134.

In the example of FIG. 2, the technician computing device 102 includes one or more processors 202 and memory 204 communicatively coupled to the processor(s) 202. The technician computing device 102 can include a UI module 206, an implementation module 208, a scoring module 210 and a recommendation module 212 stored in the memory 204. As used herein, the term “module” is intended to represent example divisions of executable instructions for purposes of discussion, and is not intended to represent any type of requirement or required method, manner or organization. Accordingly, while various “modules” are described, their functionality and/or similar functionality could be arranged differently (e.g., combined into a fewer number of modules, broken into a larger number of modules, etc.). Further, while certain functions and modules are described herein as being implemented by software and/or firmware executable on a processor, in other instances, any or all of the modules can be implemented in whole or in part by hardware (e.g., a specialized processing unit, etc.) to execute the described functions. In various implementations, the modules described herein in association with the technician computing device 102 can be executed across multiple devices.

In various examples, memory 204 can further store a database (e.g., database 114) that maintains resolution paths, resolution actions, and scores. The technician computing device 102 can also include a display 214 and one or more network interfaces 216 by which the technician computing device 102 is able to communicate with other devices over a network 108. In some examples, the database can be stored on a memory of a service 106, and the network interface 216 enables the technician computing device 102 to access data stored on the database via the network 108.

The UI module 206 can be executable by the one or more processors 202 to present a user interface (UI) on display 214 (e.g., UI 121 in FIG. 1). When a technician initiates an investigation of a user issue, the UI module 206 can generate an interactive user interface to assist technicians as they attempt to resolve a user issue. The UI can include one or more visual representations (e.g., visual representation 122) of resolution paths that correspond to one or more recommended resolution paths. In some examples, the visual representation of a resolution path can be a directed acyclic graph, where individual nodes of the graph can correspond to individual resolution actions. In some examples, the UI can enable the technician to edit a resolution path represented by a visual representation on the UI. For example, the UI can include one or more menus, selectable options, etc. that enable the technician to add, remove, replace, etc. one or more resolution actions within the resolution path.

The UI can also include one or more selectable resolution actions separate from the visual representation of a resolution path. The UI can also include a selectable option (e.g., drop down menu, toolbar, selectable icons, etc.) that enables the technician to select the type of resolution actions that are presented as selectable resolution actions on the UI. The UI can also include one or more recommended resolution actions. In some examples, the UI allows the technician to create a new resolution path by selecting one or more of the selectable resolution actions and/or the recommended resolution actions presented on UI.

In some instances, a selection of an individual node, a selectable resolution action, and/or a recommended resolution action included within the UI can cause the implementation module 208 to implement and or execute a corresponding resolution action. In some examples, a selection of an individual node, a selectable resolution action, and/or a recommended resolution action can cause a corresponding resolution action to be presented in a command box. The UI can further include a selectable option to execute and/or implement the resolution action presented within the command box.

The scoring module 210 can be executable by the one or more processors 202 to assign scores to one or more resolution paths stored in the database. The resolution paths stored in the database can be created and/or used by one or more different technicians to resolve many different types of user issues. When a technician initiates an investigation of a user issue, the scoring module 210 can access information associated with the user issue (e.g., notifications, error logs, technician input, issue type, error classifications, etc.). The scoring module 210 can assign scores to individual resolution paths stored in the database, wherein the scores reflect the likelihood that a corresponding resolution path represents the best course of action for the technician to implement and/or execute to resolve the user issue.

In some instances, the scoring module 210 can utilize the user issue information to identify a set of resolution paths in the database that is related to the user issue, and then assign scores to individual resolution paths in the set. For example, the scoring module 210 can identify resolution paths that are each related to the same or similar type of issue as the user issue. Alternatively or in addition, the set of resolution paths that are identified by the scoring module 210 as being related to the user issue can only include resolution paths that have been utilized by a technician within a particular period of time. For example, the scoring module 210 can only identify resolution paths that have been used by a technician in the last day, the last week, the last month, and so forth. In some examples, the scoring module 210 can dynamically determine the period of time based at least partly on the number of resolution paths stored in the database that are related to the user issue. The scoring module 210 can then assign a score to individual resolution paths of the set of resolution paths.

In some instances, the scoring module 210 can assign the scores based at least partly on how often the resolution path is used by technicians, and/or the amount of time that has expired since the resolution path was last used. For example, a resolution path that is often employed by technicians to resolve issues of the same or similar type as the user issue is likely to be effective in resolving the user issue. Moreover, the larger the amount of time that has elapsed since a resolution path was last used, the greater the likelihood that the issue that the resolution path resolves has been fixed (e.g., via a global software patch). In other words, a large amount of time since a resolution path was last used can reflect a high likelihood that the resolution path is obsolete.

In some instances, the scoring module 210 can assign multiple different types of scores to an individual resolution path. The different types of scores can include, for example, a usability score reflecting how often the resolution path is used, a last access time indicating the last time the resolution path was used, an action usability score that reflects how often the collection of resolution actions that comprise the resolution path is used.

The scoring module 210 can also be executable by the one or more processors 202 to assign scores to one or more resolution actions stored in the database. The scoring module 210 can assign scores to an individual resolution action stored in the database, wherein the scores reflect the likelihood that a corresponding resolution action represents an action for the technician to implement and/or execute to resolve the user issue. The scoring module 210 can assign scores to individual resolution actions based at least partly on one or more of the user information and one or more selections received by the UI. For example, when the UI receives a selection of a resolution action (e.g., during progression through a recommended resolution path, when editing a resolution path, during creation of a new resolution path, etc.) the scoring module 210 can assign the score based at least partly on a location that the corresponding resolution action is to be included within a resolution path. For example, where a resolution action is to be inserted into the resolution path before a selected resolution action, the scoring module 210 can assign a score that reflects a likelihood that the resolution action is the best action to precede the selected action to resolve the user issue. Similarly, where the resolution action is to be inserted as a next action in a resolution path, the scoring module can assign a score that reflects a likelihood that the resolution action is the best action for the technician to next execute/implement to resolve the user issue.

The recommendation module 212 can be executable by the one or more processors 202 to identify one or more recommended resolution paths from the one or more resolutions paths stored in the database. For example, based upon one or more scores (such as the scores assigned by scoring module 210), the recommendation module 212 can identify the one or more resolution paths that are presented as visual representations included on the UI. The recommendation module 212 can identify the resolution paths that correspond to the best course of action for the technician to implement and/or execute to resolve the user issue. For example, the recommendation module 212 can select a preset number of recommended resolution paths having a highest score, select the resolution paths that have been assigned one or more scores exceeding one or more thresholds, or a combination thereof. In some examples, when the recommendation module 212 is unable to identify an appropriate resolution path to resolve a user issue, the user interface may not identify a recommended resolution path.

The recommendation module 212 can further be executable by the one or more processors 202 to identify one or more recommended resolution actions (e.g., recommended resolution actions 130 in FIG. 1). For example, the recommendation module 212 can identify the recommended resolution actions from the one or more resolutions actions stored in the database based at least in part on a determination that the resolution actions have a high likelihood of being best resolution actions for the technician to implement and/or execute to resolve the user issue. In some examples, the recommendation module 212 determines which resolution action to recommend at least partly based on a previous action executed and/or implemented by a technician.

In some instances, the recommendation module 212 can dynamically generate a recommended resolution path made up of an ordered combination of one or more resolution actions based at least partly on the scores assigned to the resolution actions. The recommendation module 212 can generate the recommended resolution path based on the scores indicating a likelihood that the ordered combination of resolution actions represents the best course of action to resolve the user issue. For example, the recommendation module 212 can determine that a resolution action “RA1” has the best likelihood of being the best first action for the user to employ to resolve the user issue, “RA2” has the best likelihood of being the best second action for the user to employ after “RA1” to resolve the user issue, and “RA3” has the best likelihood of being the best third action for the user to employ to resolve the user issue. The UI module 206 can then present the resolution path (RA1, RA2, RA3) on the UI.

In some instances, the implementation module 208 is further executable by the one or more processors 202 to determine that the user issue is resolved (e.g., via a notification from user computing device, input from technician via the UI, etc.). Based on this determination, the implementation module 208 updates the data stored in the database to reflect that a particular resolution path (e.g., the selected resolution path, the edited resolution path, the new resolution path, etc.) successfully resolved the user issue. In some examples, updating the data in the database can include storing the new/edited resolution path as a new resolution path in the database. The scoring module 210 can also assign one or more new scores based on the resolution path and resolution actions employed by the technician to resolve the issue. In this way, each time the technician (or a different technician) initiates an investigation relating to a user issue (e.g., when a second user experiences one of the same user issue, a similar user issue, or a new user issue), the scoring module 210 and the recommendation module respectively assigns scores and makes recommendations based upon prior technician experience.

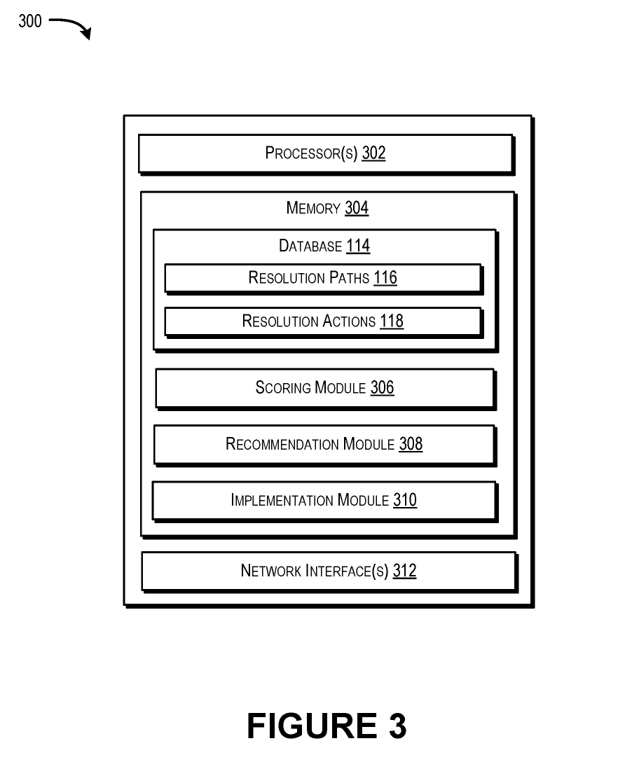

FIG. 3 is a schematic diagram 300 illustrating components of an example server device configured to provide a user interface to recommend a resolution path and/or resolution actions to resolve a user issue. FIG. 3 illustrates additional details of hardware and software components that can be used to implement the techniques described above with respect to FIG. 1.

In the example of FIG. 3, the server includes one or more processors 302 and memory 304 communicatively coupled to the processor(s) 302. The server can include a database 114, a scoring module 306, a recommendation module 308, and a implementation module 310 stored in the memory 304. The scoring module 306, the recommendation module 308, and the implementation module 310 are each configured to perform similar functionality to that described above with regard to the scoring module 210, the recommendation module 212, and the implementation module 208, respectively. As described above, the database 114 can include one or more resolution paths 116 and one or more resolution actions 118. The server can also include and one or more network interfaces 312 by which the server is able to communicate with other devices over a network 108.

A resolution path 116 can comprise one or more resolution actions 118 (e.g., a series of resolution actions) that can be implemented and/or executed via a technician computing device to resolve a user issue. The resolution paths 116 stored in the database 114 can have been created and/or used by one or more different technicians to resolve many different types of user issues. A resolution action 118 can include an individual step or operation that can be implemented and/or executed via a technician computing device during the resolution of the user issue. The server can make the database 114 available to one or more of the technician computing device 102 and/or additional technician computing devices 136.

In some instances, the implementation module 310 is executable by the one or more processors 302 to determine that the user issue is resolved (e.g., via a notification from user computing device, input from technician via the UI, etc.). Based on this determination, the implementation module 310 can cause the resolution paths 116 and resolution actions 118 stored in the database 114 to be updated to reflect that the particular resolution path (e.g., the selected resolution path, the edited resolution path, the new resolution path, etc.) has successfully resolved the user issue. In some examples, updating the data in the database can include storing the new/edited resolution path as a new resolution path in the database. The implementation module 310 can also update one or more scores based on the resolution path and resolution actions employed by the technician to resolve the issue. In some examples, the implementation module 310 also updates the resolution paths 116 and resolution actions 118 stored in the database 114 in response to actions performed by the additional technicians via the additional technician computing devices during the resolution of user issues.

The one or more processor(s) 202 and 302 can be configured to execute instructions, applications, or programs stored in the memory 204 and 304. In some examples, the one or more processor(s) 202 and 302 can include hardware processors that include, without limitation, a hardware central processing unit (CPU), a graphics processing unit (GPU), a field programmable gate array (FPGA), a complex programmable logic device (CPLD), an application specific integrated circuit (ASIC), a system-on-chip (SoC), or a combination thereof.

The memory 204 and 304 is an example of computer-readable media. Computer-readable media can include two types of computer-readable media, namely computer storage media and communication media. Computer storage media can include volatile and non-volatile, removable, and non-removable media implemented in any method or technology for storage of information, such as computer readable instructions, data structures, program modules, or other data. Computer storage media includes, but is not limited to, random access memory (RAM), read-only memory (ROM), erasable programmable read-only memory (EEPROM), flash memory or other memory technology, compact disc read-only memory (CD-ROM), digital versatile disk (DVD), or other optical storage, magnetic cassettes, magnetic tape, magnetic disk storage or other magnetic storage devices, or any other non-transmission medium that can be used to store the desired information and which can be accessed by a computing device, such as the technician computing device 102, the user computing devices 110, or a server that maintains the database 114. In general, computer storage media can include computer-executable instructions that, when executed by one or more processors, cause various functions and/or operations described herein to be performed.

In contrast, communication media embody computer-readable instructions, data structures, program modules, or other data in a modulated data signal, such as a carrier wave, or other transmission mechanism. As defined herein, computer storage media does not include communication media.

Additionally, the network interface 216 and 312 includes physical and/or logical interfaces for connecting the respective computing device(s) to another computing device or a network. For example, the network interface 216 and 312 can enable WiFi-based communication such as via frequencies defined by the IEEE 802.11 standards, short range wireless frequencies such as Bluetooth®, or any suitable wired or wireless communications protocol that enables the respective computing device to interface with the other computing devices.

The architectures, systems, and individual elements described herein can include many other logical, programmatic, and physical components, of which those shown in the accompanying figures are merely examples that are related to the discussion herein.

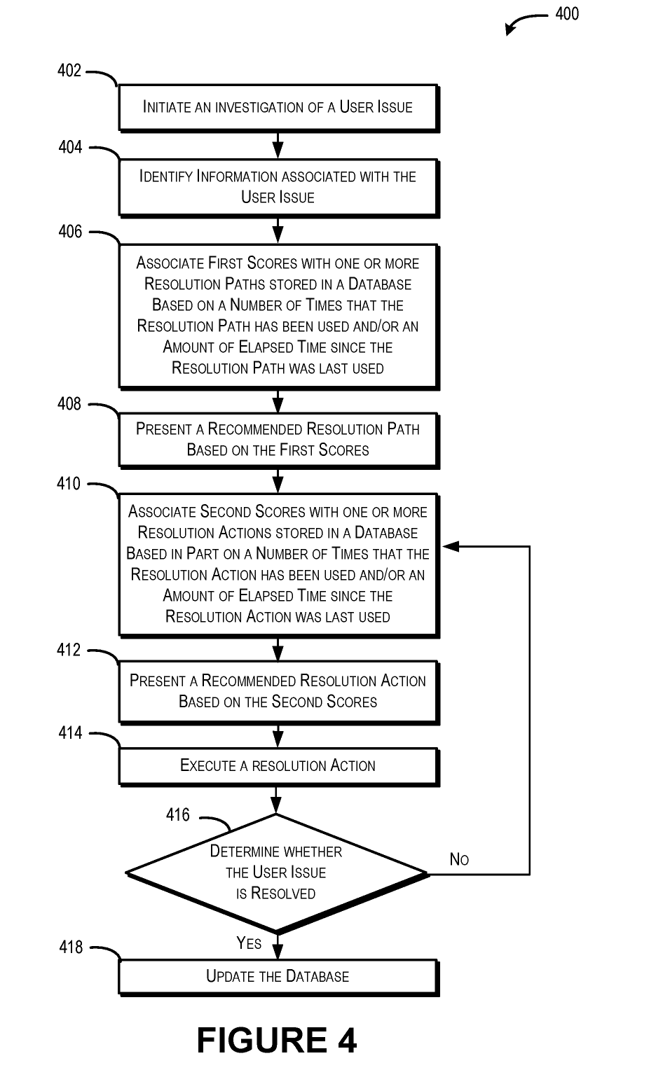

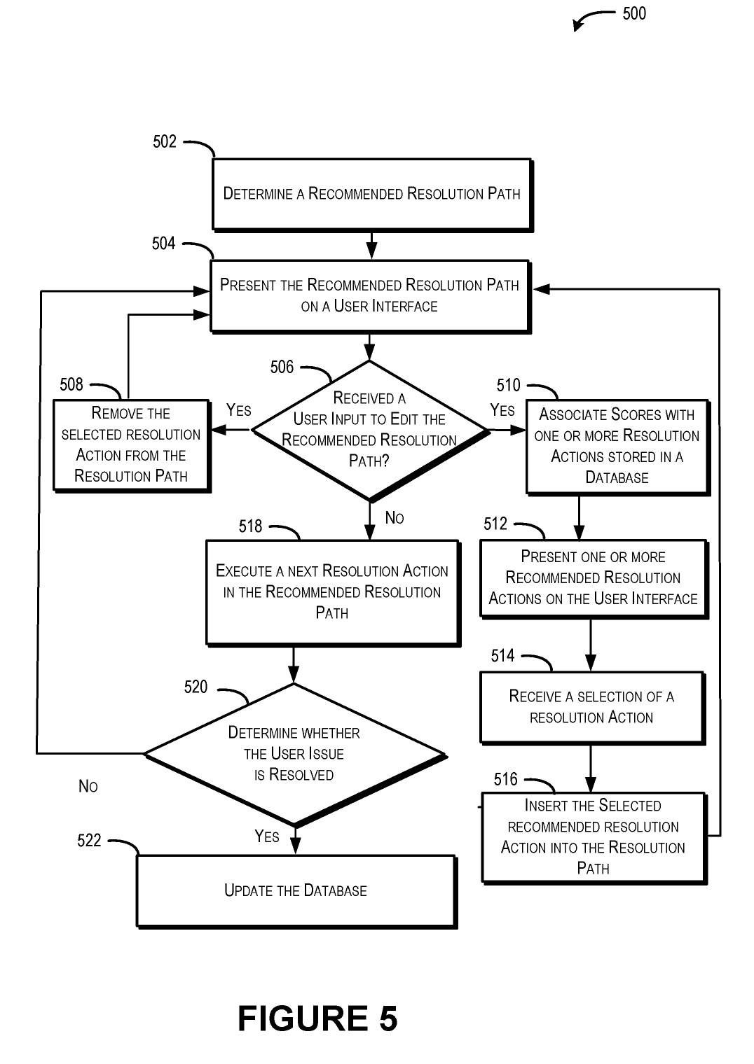

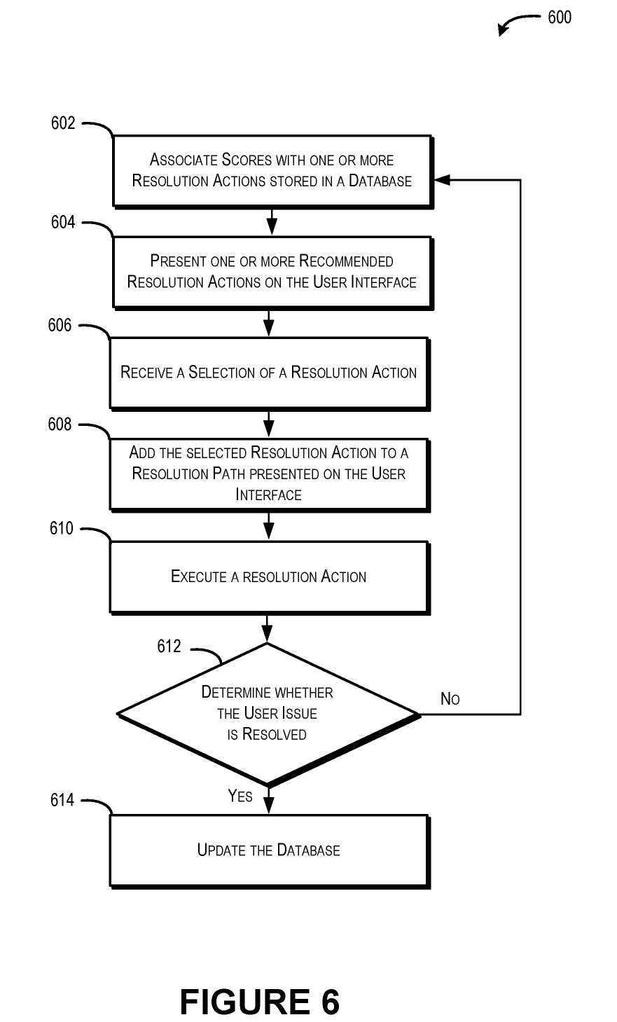

FIG. 4, as well as FIGS. 5 and 6, individually illustrate an example process for employing the techniques described herein. For ease of illustration, the example processes are described as being performed in the environment 100 of FIG. 1, the environment 200 of FIG. 2, and/or the environment 300 of FIG. 3. However, the example processes can be performed in other environments and by other devices as well. The example processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, configure a device to perform the recited operations. Generally, computer-executable instructions include routines, programs, objects, components, data structures, and the like that perform particular functions. The order in which the operations are described is not intended to be construed as a limitation, and any number of the described operations can be combined in any order and/or in parallel to implement the process. Further, any of the individual operations can be omitted.

FIG. 4 illustrates a flow diagram of an example process 400 for providing technicians with user interfaces configured to recommend resolution paths and/or resolution actions to resolve a user issue.

At 402, an investigation of a user issue is initiated. For example, a technician computing device (as described with respect to reference 102 in FIGS. 1 and 2) can receive an input from technician to initiate an investigation of a user issue experienced by a user with regard to one or more user computing devices (as described with respect to reference 110 in FIG. 1).

At 404, information associated with the user issue is identified. For example, the technician computing device can access one or more notifications, error logs, technician input, issue type, error classifications, etc. received from the user via a user computing device.

At 406, scores are associated with one or more resolution paths stored in a database. Individual assigned scores can reflect the likelihood that a corresponding resolution path represents the best course of action for the technician to implement and/or execute to resolve the user issue. In some examples, the scores can be assigned based at least partly on how often the resolution path is used by technicians, and/or the amount of time that has expired since the resolution path was last used. For example, a resolution path that is often employed by technicians to resolve issues of the same or similar type as the user issue is likely to be effective in resolving the user issue. Moreover, the larger the amount of time that has elapsed since a resolution path was last used, the greater the likelihood that the issue that the resolution path resolves has been fixed (e.g., via a global software patch).

At 408, one or more recommended resolution paths are presented on a user interface. For example, based upon one or more scores (e.g., the scores assigned by scoring module 210), a computing system can identify resolution paths that correspond to the best course of action for the technician to implement and/or execute to resolve the user issue. For example, the computing system can select a preset number of recommended resolution paths having the highest scores, select the resolution paths that have been assigned scores exceeding a threshold score, or a combination thereof.

The computing system can then present the one or more recommended resolution paths on a user interface (UI) on a display of the technician computing device. The recommended resolution paths can be presented on the UI as one or more visual representations. In some examples, the visual representation can be directed acyclic graphs, where individual nodes of the graph can correspond to individual resolution actions of a recommended resolution path. In some examples, the UI can enable the technician to edit a resolution path represented by a visual representation on the UI.

At 410, scores are associated with one or more resolution actions stored in a database. The computing system can assign scores to individual resolution actions stored in the database that reflect a likelihood that the corresponding resolution action represents a best action for the technician to implement and/or execute to resolve the user issue. For example, the computing system can assign scores to individual resolution actions based on at least one of a number of times the corresponding resolution action has been used and an amount of elapsed time since the corresponding resolution action was last used.

The computing system can assign scores to individual resolution actions based at least partly on the user issue information.

In some instances, the computing system can associate scores with the resolution actions following a selection of a user action by the technician via the UI. For example, in response to the selection of a particular resolution action, the computing system can assign scores to individual resolution actions that reflect a likelihood that the corresponding resolution action represents the best resolution action to precede, follow, and/or replace the selected particular resolution action.

At 412, one or more recommended resolution actions are presented on the user interface. For example, the computing system can identify the recommended resolution actions from the one or more resolutions actions stored in the database based at least in part on a determination that the resolution actions have a high likelihood of being the best resolution actions for the technician to implement and/or execute to resolve the user issue. In some examples, the computing system determines which resolution actions to recommend at least partly based on a previous action executed and/or implemented by technician.

At 414, a resolution action is executed. In some examples, a selection of a resolution action presented on the user interface can cause the computing device to execute the resolution action. In some examples, a selection of a resolution action presented on the UI can cause the resolution action to be presented in command box included in the UI. A technician can then execute the resolution action via the command box.

At 416, it is determined whether the user issue is resolved. If the answer at 416 is “no,” then the process returns to operation 410 and new scores are associated with one or more resolution actions stored in the database. As discussed above, the new scores can be associated with the resolution actions based at least partly on previous execution and/or non-execution of a previous resolution action.

If the answer at 416 is “yes” (an indication that the user issue has been resolved is received), then the process moves to 418 and the database is updated. For example, the computing system can update the database to reflect that the resolution path (e.g., the selected resolution path, the edited resolution path, the new resolution path, etc.) successfully resolved the user issue. In some examples, the computing system can update the database to include the new/edited resolution path and/or change one or more the scores associated with the version of the resolution path stored in the database. In this way, the next time a technician initiates an investigation relating to the user issue (e.g., when a second user experiences the user issue), the scores and recommendations are based at least partly on the updated database.

FIG. 5 illustrates a flow diagram of an example process 500 for providing technicians with an interactive graphical user interface to assist the technician in editing a resolution path to resolve a user issue.

At 502, a recommended resolution path is determined. Determining the recommended resolution path can include identifying information associated with the user issue, and associating scores with one or more resolution paths stored in a database based at least partly on the information. Individual assigned scores can reflect the likelihood that a corresponding resolution path represents the best course of action for the technician to implement and/or execute to resolve the user issue. In some examples, the recommended resolution path can be determined by a computing system. The computing system can then determine the recommend resolution path based on the score.

At 504, the recommended resolution path is presented on a user interface (UI). The recommended resolution path can be presented on the UI as one or more visual representations. In some instances, the visual representation can be a directed acyclic graph, where individual nodes of the graph can correspond to individual resolution actions of the recommended resolution path.

At 506, it is determined whether a user input to edit the recommended resolution path has been received.

In at least one implementation, if the answer at 506 is “yes,” and if the user input corresponds to a UI selection to remove a resolution action from the recommended resolution path, then the process continues to operation 508 where the selected resolution action is removed from the recommended resolution path. The process then returns to operation 504, where the edited recommended resolution path is presented on the user interface. For example, the computing system can remove a node corresponding to the selected resolution action from a directed acyclic graph presented on the UI. Alternatively, the computing system can present a visual indicator (e.g., a grayed out node) that the selected resolution action has been removed.

In at least one implementation, if the answer at 506 is “yes,” and if the user input corresponds to a UI selection to add a resolution action to the recommended resolution path, then the process continues to operation 510 where scores are associated with one or more resolution actions stored in a database. For example, the computing system can assign scores to individual resolution action stored in the database that reflect a likelihood that the corresponding resolution action represents a best action for the technician to implement and/or execute to resolve the user issue. The computing system can assign scores to individual resolution actions based at least partly on the user issue information. The computing system can assign scores to individual resolution actions that reflect a likelihood that the corresponding resolution action represents the best resolution action to precede, follow, and/or replace the selected particular resolution action.

At 512, the one or more recommended resolution actions are presented on the user interface. For example, the computing system can identify the recommended resolution actions from the one or more resolutions actions stored in the database based at least in part on a determination that the resolution actions have a high likelihood of being best resolution actions for the technician to implement and/or execute to resolve the user issue. In some examples, the computing system determines which resolution actions to recommend at least partly based on a location within the recommended resolution path at which the new resolution action is to be added.

At 514, a selection of a resolution action is received. The selection can correspond to a selection of one of the one or more recommended resolution actions presented on the user interface. Alternatively, the selection can correspond to a selection of a different resolution action presented on the user interface. The selection can also correspond to a technician entering a resolution action into the user interface (e.g., by typing an action command into a command box on the user interface).

At 516, the selected recommended resolution action is inserted into the recommended resolution path. The process then returns to operation 504, where the edited recommended resolution path is presented on the user interface. For example, the computing system can add a node corresponding to the selected resolution action to a directed acyclic graph presented on the UI.

If the answer at 506 is “no,” then the process continues to operation 518 and a next resolution action in the recommended resolution path is executed. In some examples, a selection of a resolution action presented on the user interface can cause the computing device to execute the resolution action. In some examples, a selection of a resolution action presented on the UI can cause the resolution action to be presented in command box included in the UI. A technician can then execute the resolution action via the command box.

At 520, it is determined whether the user issue is resolved.

If the answer at 520 is “no,” then the process returns to operation 504 and the recommended resolution path is presented on the user interface.

If the answer at 520 is “yes” (an indication that the user issue has been resolved is received), then the process moves to 522 and the database is updated. For example, the computing system can update the database to reflect that the resolution path (e.g., the selected resolution path, the edited resolution path, the new resolution path, etc.) successfully resolved the user issue. In some examples, the computing system can update the database to include the new/edited resolution path and/or change one or more the scores associated with the version of the resolution path stored in the database. In this way, the next time a technician initiates an investigation relating to the user issue (e.g., when a second user experiences the user issue), the scores and recommendations are based at least partly on the updated database.

FIG. 6 illustrates a flow diagram of an example process 600 for providing technicians with an interactive graphical user interface that assists technicians in generating a new resolution path to resolve a user issue.

At 602, scores are associated with one or more resolution actions stored in a database. For example, a computing system can assign scores to individual resolution action stored on the database that reflect a likelihood that the corresponding resolution action represents a best action for the technician to implement and/or execute to resolve the user issue. The computing system can assign scores to individual resolution actions based at least partly on user issue information associated with a user issue.

In some instances, the computing system can associate scores with the resolution actions following a selection of a user action by the technician via the UI. For example, in response to the selection of a particular resolution action, the computing system can assign scores to individual resolution actions that reflect a likelihood that the corresponding resolution action represents the best resolution action to precede, follow, and/or replace the selected particular resolution action.

At 604, one or more recommended resolution actions are presented on the user interface. For example, the computing system can identify the recommended resolution actions from the one or more resolutions actions stored in the database based at least in part on a determination that the resolution actions have a high likelihood of being best resolution actions for the technician to implement and/or execute to resolve the user issue. In some examples, the computing system determines which resolution actions to recommend at least partly based on a previous action executed and/or implemented by technician.

At 606, a selection of a resolution action is received. The selection can correspond to a selection of one of the one or more recommended resolution actions presented on the user interface. Alternatively, the selection can correspond to a selection of a different resolution action presented on the user interface. The selection can also correspond to a technician entering a resolution action into the user interface (e.g., by typing an action command into a command box on the user interface).

At 608, the selected recommended resolution action is inserted into a recommended resolution path presented on the user interface. For example, the computing system can add a node corresponding to the selected resolution action to a directed acyclic graph presented on the UI.

At 610, a resolution action is executed. In some instances, a selection of a resolution action presented on the user interface can cause the computing device to execute the resolution action. In some examples, a selection of a resolution action presented on the UI can cause the resolution action to be presented in command box included in the UI. A technician can then execute the resolution action via the command box.

At 612, it is determined whether the user issue is resolved.

If the answer at 612 is “no,” then the process returns to operation 602 and new scores are associated with one or more resolution actions stored in the database. As discussed above, the computing system can associate the new scores with the resolution actions based at least partly on the execution of the resolution action. For example, if a first action failed to resolve the user issue, a score associated with the first action may be decreased. Alternatively, if a second action failed to ultimately resolve the issue but moved the issue closer to resolution, a score associated with the second action may be increased.

If the answer at 612 is “yes” (e.g., the computing system receives an indication that the user issue has been resolved), then the process moves to 614 and the database is updated. For example, the computing system can update the database to reflect that the resolution path (e.g., the selected resolution path, the edited resolution path, the new resolution path, etc.) successfully resolved the user issue. In some examples, the computing system can update the database to include the new/edited resolution path and/or change one or more the scores associated with the version of the resolution path stored in the database. In this way, the next time a technician initiates an investigation relating to the user issue (e.g., when a second user experiences the user issue), the scores and recommendations will be based at least partly on the updated database.

The environment and individual elements described herein can of course include many other logical, programmatic, and physical components, of which those shown in the accompanying figures are merely examples that are related to the discussion herein.

The various techniques described herein are assumed in the given examples to be implemented in the general context of computer-executable instructions or software, such as program modules, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software can be stored and distributed in various ways and using different means, and the particular software storage and execution configurations described above can be varied in many different ways. Thus, software implementing the techniques described above can be distributed on various types of computer-readable media, not limited to the forms of memory that are specifically described.

### Example Clauses

Example A, a device, comprising: one or more processors; and a memory having instructions stored thereon that, when executed by the one or more processors, cause the device to: determine information associated with a user issue; identify, based on the information, a set of resolution paths associated with the user issue, wherein a resolution path comprises one or more actions executable to resolve at least part of the user issue; select a first resolution path from the set of resolution paths based on at least one of: a number of times that the first resolution path has been used; and an amount of elapsed time since the first resolution path was last used; and cause a visual representation of the first resolution path to be presented as a recommended resolution path.

Example B, the device of example A, wherein one or more resolution actions of the recommended resolution path comprises a first recommended action and a second recommended action, and wherein the instructions further cause the device to: receive a selection to remove the second recommended action; cause a visual indication indicating that the second recommended action has been removed from the first resolution path to be presented; and based on the selection to remove the second recommended action, decrease both a path score associated with the recommended path and an action score associated with the second recommended action.

Example C, the device of example B, wherein the visual representation is a first visual representation, and wherein the instructions further cause the device to: cause, based on a user selection, a second visual representation of a revised resolution path to be presented, the revised resolution path corresponding to the first resolution path with the second recommended action removed; determine that the user issue has been resolved based at least in part on the revised resolution path; and based on the user issue being resolved based at least in part on the revised resolution path, associate a second path score with the revised resolution path, the second path score being higher than the first path score.

Example D, the device of any of examples A-C, wherein the instructions further cause the device to: determine that the user issue has successfully been resolved; and assign a path score to the first resolution path based on successful resolution of the user issue.

Example E, the device of any of examples A-D, wherein the instructions further cause the device to: cause a visual representation of a first resolution action to be presented on the user interface, wherein the visual representation of the first resolution action is presented within the visual representation of the first resolution path; receive a selection of the first resolution action; cause, based at least partly on the selection of the first resolution action, a recommended second resolution action to be presented on the user interface.

Example F, the device of any of examples A-E, wherein the instructions further cause the device to determine a first path score associated with the first resolution path based at least in part on one or more of the number of times that the first resolution path has been used or the amount of elapsed time since the first resolution path was last used.

Example G, the device of any of examples A-D, wherein the set of resolution paths is stored in a data store, the set of resolution paths being accessible by a plurality of users, and wherein the instructions cause the device to further base the selection of the first resolution path at least partly on a cumulative usage of the first resolution path by the plurality of users.

Example H, a method comprising: receiving information associated with a user issue; identifying, based on the information, a set of resolution paths associated with the user issue, wherein a resolution path comprises one or more actions executable to resolve at least part of the user issue; selecting at least a first resolution path from the set of resolution paths based on at least one of: a number of times that an action of the first resolution path has been used; and an amount of elapsed time since the action of the first resolution path was last used; and causing a visual representation of the first resolution path to be presented on a user interface as a recommended resolution path.

Example I, the method of example H, wherein the first resolution path comprises a first recommended action and a second recommended action, and the method further comprising: receiving a selection to remove the second recommended action; causing a visual indication that the second recommended action has been removed from the first resolution path to be presented on the user interface; and based on the selection to remove the second recommended action, updating the at least one path score associated with the second recommended action.

Example J, the method of any of examples H and I, further comprising: determining that the user issue is resolved; and assigning a path score to the first resolution path based at least in part on the resolution of the user issue.

Example K, the method of any of examples H-J, further comprising: causing a visual representation of a first resolution action to be presented on the user interface, wherein the visual representation of the first resolution action is presented within the visual representation of the first resolution path; receiving a selection of the first resolution action; causing, based at least partly on the selection of the first resolution action, a recommended second resolution action to be presented on the user interface.

Example L, the method of any of examples H-K, further comprising: receiving a selection to add an additional resolution action to the first resolution path; and adding the additional resolution action to the first resolution path.

Example M, the method of any of examples H-L, further comprising determining a path score associated with the first resolution path based at least in part on one or more of a number of times that the first resolution path has been used or an amount of elapsed time since the first resolution path was last used.

Example N, the method of any of examples H-J, wherein the set of resolution paths are stored in a data store, the set of resolution paths being accessible by a plurality of users, and wherein the selection of the at least the first resolution path from the set of resolution paths is further based at least partly on cumulative usages of individual resolution paths of the at least the first resolution path by the plurality of users.

Example O, a device, comprising: one or more processors; and a memory having instructions stored thereon that, when executed by the one or more processors, cause the device to: receive information associated with a user issue; identify, based on the information, a set of resolution paths associated with the user issue, wherein a resolution path comprises one or more actions executable to resolve at least part of the user issue; identify, based on the information, a set of resolution actions associated with the user issue; and cause a user interface to be presented on a display, the user interface including: at least a first resolution path of the set of resolution paths based at least partly on a first number of times that the first resolution path has been used or a first amount of elapsed time since the first resolution path was last used, and at least a first resolution action of the set of resolution actions based at least partly on a second number of times that the first resolution action has been used or a second amount of elapsed time since the first resolution action was last used.

Example P, the device of example O, wherein the first resolution path comprises a first recommended action and a second recommended action, and wherein the instructions further cause the device to: receive a selection to remove the second recommended action; cause a visual indication that the second recommended action has been removed from the first resolution path to be presented on the user interface; and based on the selection to remove the second recommended action, update a score associated with the second recommended action.

Example Q, the method of any of examples O and P, wherein the first resolution path comprises a first recommended action and a second recommended action, and wherein the instructions further cause the device to: receive a selection to add a third recommended action to the first resolution path; associate, based at least in part on the addition of the third recommended action to the first resolution path, individual scores with the individual resolution actions of the set of resolution actions; cause at least a second resolution action of the set of resolution actions to be presented based at least partly on the second resolution action having a highest associated score; receive a selection of the second resolution action; causing a visual indication that the second resolution action has been added to the first resolution path to be presented on the user interface.

Example R, the method of any of examples O-Q, wherein the instructions further cause the device to: determine that the user issue has been resolved; and assign a path score to the first resolution path based on successful resolution of the user issue.

Example S, the method of any of examples O-R, wherein the instructions further cause the device to determine a first path score associated with the first resolution path based at least in part on one or more of the number of times that the first resolution path has been used or the amount of elapsed time since the first resolution path was last used.

Example T, the method of any of examples O-S, wherein the set of resolution paths is stored in a data store on a server, the set of resolution paths being accessible by a plurality of users, and wherein the instructions further cause the device to select at least the first resolution path of the set of resolution paths for presentation on the display, the selection being based at least partly on cumulative usages of individual resolution paths of the at least the first resolution path by the plurality of users.

Example U, a computing system comprising: means for determining information associated with a user issue; means for identifying, based on the information, a set of resolution paths associated with the user issue, wherein a resolution path comprises one or more actions executable to resolve at least part of the user issue; means for selecting a first resolution path from the set of resolution paths based on at least one of: a number of times that the first resolution path has been used; and an amount of elapsed time since the first resolution path was last used; and cause a visual representation of the first resolution path to be presented as a recommended resolution path.

Example V, the computing system of example U, wherein one or more resolution actions of the recommended resolution path comprises a first recommended action and a second recommended action, and further comprising means for receiving a selection to remove the second recommended action; means for causing a visual indication indicating that the second recommended action has been removed from the first resolution path to be presented; and means for decreasing, based on the selection to remove the second recommended action, both a path score associated with the recommended path and an action score associated with the second recommended action.

Example W, the computing system of example V, wherein the visual representation is a first visual representation, and further comprising means for causing, based on a user selection, a second visual representation of a revised resolution path to be presented, the revised resolution path corresponding to the first resolution path with the second recommended action removed; means for determining that the user issue has been resolved based at least in part on the revised resolution path; and means for associating, based on the user issue being resolved based at least in part on the revised resolution path, a second path score with the revised resolution path, the second path score being higher than the first path score.

Example X, the computing system of any of examples U and V, further comprising means for determining that the user issue has successfully been resolved; and means for assigning a path score to the first resolution path based on successful resolution of the user issue.

Example Y, the computing system of any of examples U-X, further comprising means for causing a visual representation of a first resolution action to be presented on the user interface, wherein the visual representation of the first resolution action is presented within the visual representation of the first resolution path; means for receiving a selection of the first resolution action; means for causing, based at least partly on the selection of the first resolution action, a recommended second resolution action to be presented on the user interface.

Example Z, the computing system of any of examples U-Y, further comprising means for determining a first path score associated with the first resolution path based at least in part on one or more of the number of times that the first resolution path has been used or the amount of elapsed time since the first resolution path was last used.

Example AA, the computing system of any of examples U-Z, wherein the set of resolution paths is stored in a data store, the set of resolution paths being accessible by a plurality of users, and further comprising means for causing the device to further base the selection of the first resolution path at least partly on a cumulative usage of the first resolution path by the plurality of users.

Example BB, a computing device, comprising means for causing the device to: receive information associated with a user issue; means for identifying, based on the information, a set of resolution paths associated with the user issue, wherein a resolution path comprises one or more actions executable to resolve at least part of the user issue; means for identifying, based on the information, a set of resolution actions associated with the user issue; and means for causing a user interface to be presented on a display, the user interface including: at least a first resolution path of the set of resolution paths based at least partly on a first number of times that the first resolution path has been used or a first amount of elapsed time since the first resolution path was last used, and at least a first resolution action of the set of resolution actions based at least partly on a second number of times that the first resolution action has been used or a second amount of elapsed time since the first resolution action was last used.

Example CC, the computing device of example BB, wherein the first resolution path comprises a first recommended action and a second recommended action, and further comprising means for receiving a selection to remove the second recommended action; means for causing a visual indication that the second recommended action has been removed from the first resolution path to be presented on the user interface; and means for updating, based on the selection to remove the second recommended action, a score associated with the second recommended action.

Example DD, the computing device of any of examples BB and CC, wherein the first resolution path comprises a first recommended action and a second recommended action, and further comprising means for receiving a selection to add a third recommended action to the first resolution path; means for associating, based at least in part on the addition of the third recommended action to the first resolution path, individual scores with the individual resolution actions of the set of resolution actions; means for causing at least a second resolution action of the set of resolution actions to be presented based at least partly on the second resolution action having a highest associated score; means for receiving a selection of the second resolution action; means for causing a visual indication that the second resolution action has been added to the first resolution path to be presented on the user interface.

Example EE, the computing device of any of examples BB-DD, further comprising means for determining that the user issue has been resolved; and means for assigning a path score to the first resolution path based on successful resolution of the user issue.

Example FF, the computing device of any of examples BB and EE, further comprising means for determining a first path score associated with the first resolution path based at least in part on one or more of the number of times that the first resolution path has been used or the amount of elapsed time since the first resolution path was last used.

Example GG, the computing device of any of examples BB and FF, wherein the set of resolution paths is stored in a data store on a server, the set of resolution paths being accessible by a plurality of users, and further comprising means for selecting at least the first resolution path of the set of resolution paths for presentation on the display, the selection being based at least partly on cumulative usages of individual resolution paths of the at least the first resolution path by the plurality of users.

### CONCLUSION

In closing, although the various implementations can have been described in language specific to structural features and/or methodological acts, it is to be understood that the subject matter described is not necessarily limited to the specific features or acts described. Rather, the specific features and acts are disclosed as example forms of implementing the claimed subject matter.

What is claimed is:

1. A device, comprising:
one or more processors; and
a memory having instructions stored thereon that, when executed by the one or more processors, cause the device to:
determine information associated with a user issue;
identify, based on the information, a set of resolution paths associated with the user issue, wherein a resolution path comprises one or more actions executable to resolve at least part of the user issue;
select a first resolution path from the set of resolution paths based on at least one of:
a number of times that the first resolution path has been used; and
an amount of elapsed time since the first resolution path was last used; and
cause a visual representation of the first resolution path to be presented as a recommended resolution path.

2. The device of claim 1, wherein one or more resolution actions of the recommended resolution path comprises a first recommended action and a second recommended action, and wherein the instructions further cause the device to:
receive a selection to remove the second recommended action;
cause a visual indication indicating that the second recommended action has been removed from the first resolution path to be presented; and
based on the selection to remove the second recommended action, decrease both a path score associated with the recommended path and an action score associated with the second recommended action.

3. The device of claim 2, wherein the visual representation is a first visual representation, and wherein the instructions further cause the device to:
cause, based on a user selection, a second visual representation of a revised resolution path to be presented, the revised resolution path corresponding to the first resolution path with the second recommended action removed;
determine that the user issue has been resolved based at least in part on the revised resolution path; and
based on the user issue being resolved based at least in part on the revised resolution path, associate a second path score with the revised resolution path, the second path score being higher than the first path score.

4. The device of claim 1, wherein the instructions further cause the device to:
determine that the user issue has successfully been resolved; and
assign a path score to the first resolution path based on successful resolution of the user issue.

5. The device of claim 1, wherein the instructions further cause the device to:
cause a visual representation of a first resolution action to be presented on the user interface, wherein the visual representation of the first resolution action is presented within the visual representation of the first resolution path;
receive a selection of the first resolution action;
cause, based at least partly on the selection of the first resolution action, a recommended second resolution action to be presented on the user interface.

6. The device of claim 1, wherein the instructions further cause the device to determine a first path score associated with the first resolution path based at least in part on one or more of the number of times that the first resolution path has been used or the amount of elapsed time since the first resolution path was last used.

7. The device of claim 1, wherein the set of resolution paths is stored in a data store, the set of resolution paths being accessible by a plurality of users, and wherein the instructions cause the device to further base the selection of the first resolution path at least partly on a cumulative usage of the first resolution path by the plurality of users.

8. A method comprising:
receiving information associated with a user issue;
identifying, based on the information, a set of resolution paths associated with the user issue, wherein a resolution path comprises one or more actions executable to resolve at least part of the user issue;
selecting at least a first resolution path from the set of resolution paths based on at least one of:
a number of times that an action of the first resolution path has been used; and
an amount of elapsed time since the action of the first resolution path was last used; and
causing a visual representation of the first resolution path to be presented on a user interface as a recommended resolution path.

9. The method of claim 8, wherein the first resolution path comprises a first recommended action and a second recommended action, and the method further comprising:
receiving a selection to remove the second recommended action;
causing a visual indication that the second recommended action has been removed from the first resolution path to be presented on the user interface; and
based on the selection to remove the second recommended action, updating the at least one path score associated with the second recommended action.

10. The method of claim 8, further comprising:
determining that the user issue is resolved; and
assigning a path score to the first resolution path based at least in part on the resolution of the user issue.

11. The method of claim 8, further comprising:
causing a visual representation of a first resolution action to be presented on the user interface, wherein the visual representation of the first resolution action is presented within the visual representation of the first resolution path;
receiving a selection of the first resolution action;
causing, based at least partly on the selection of the first resolution action, a recommended second resolution action to be presented on the user interface.

12. The method of claim 8, further comprising:
receiving a selection to add an additional resolution action to the first resolution path; and
adding the additional resolution action to the first resolution path.

13. The method of claim 8, further comprising determining a path score associated with the first resolution path based at least in part on one or more of a number of times that the first resolution path has been used or an amount of elapsed time since the first resolution path was last used.

14. The method of claim 8, wherein the set of resolution paths are stored in a data store, the set of resolution paths being accessible by a plurality of users, and wherein the selection of the at least the first resolution path from the set of resolution paths is further based at least partly on cumulative usages of individual resolution paths of the at least the first resolution path by the plurality of users.

15. A device, comprising:
one or more processors; and
a memory having instructions stored thereon that, when executed by the one or more processors, cause the device to:
receive information associated with a user issue;
identify, based on the information, a set of resolution paths associated with the user issue, wherein a resolution path comprises one or more actions executable to resolve at least part of the user issue;
identify, based on the information, a set of resolution actions associated with the user issue; and
cause a user interface to be presented on a display, the user interface including:
at least a first resolution path of the set of resolution paths based at least partly on a first number of times that the first resolution path has been used or a first amount of elapsed time since the first resolution path was last used, and
at least a first resolution action of the set of resolution actions based at least partly on a second number of times that the first resolution action has been used or a second amount of elapsed time since the first resolution action was last used.

16. The device of claim 15, wherein the first resolution path comprises a first recommended action and a second recommended action, and wherein the instructions further cause the device to:
receive a selection to remove the second recommended action;
cause a visual indication that the second recommended action has been removed from the first resolution path to be presented on the user interface; and
based on the selection to remove the second recommended action, update a score associated with the second recommended action.

17. The device of claim 15, wherein the first resolution path comprises a first recommended action and a second recommended action, and wherein the instructions further cause the device to:
receive a selection to add a third recommended action to the first resolution path;
associate, based at least in part on the addition of the third recommended action to the first resolution path, individual scores with the individual resolution actions of the set of resolution actions;
cause at least a second resolution action of the set of resolution actions to be presented based at least partly on the second resolution action having a highest associated score;
receive a selection of the second resolution action;
causing a visual indication that the second resolution action has been added to the first resolution path to be presented on the user interface.

18. The device of claim 15, wherein the instructions further cause the device to:
determine that the user issue has been resolved; and
assign a path score to the first resolution path based on successful resolution of the user issue.

19. The device of claim 15, wherein the instructions further cause the device to determine a first path score associated with the first resolution path based at least in part on one or more of the number of times that the first resolution path has been used or the amount of elapsed time since the first resolution path was last used.

20. The device of claim 15, wherein the set of resolution paths is stored in a data store on a server, the set of resolution paths being accessible by a plurality of users, and wherein the instructions further cause the device to select at least the first resolution path of the set of resolution paths for presentation on the display, the selection being based at least partly on cumulative usages of individual resolution paths of the at least the first resolution path by the plurality of users.
